(19) United States
(12) Patent Application Publication
(10) Pub. No.: US 2009/0108084 A1
(43) Pub. Date: Apr. 30, 2009

(54) Air conditioning system

(75) Inventors: Hee Jun Lee, Changwon-si (KR); Jun Shin, Changwon-si (KR)

Correspondence Address: MCKENNA LONG & ALDRIDGE LLP, 1900 K STREET, NW, WASHINGTON, DC, 20006, US

(73) Assignee: LG Electronics Inc., Seoul (KR)

(21) Appl. No.: 12/216,158

(22) Filed: Jun. 30, 2008

(30) Foreign Application Priority Data
Oct. 24, 2007 (KR) 10-2007-0107214

(51) Int. Cl. G05D 23/00; G05B 15/00

(52) U.S. Cl. 236/51; 700/276

(57) ABSTRACT

In an air conditioning system, a first controller converts the communication method of an external command inputted into the second controller and transmits the same to an air conditioner. Further, the first controller displays operating information of the air conditioner. Accordingly, the structure of the air conditioning system is simplified, and installation costs are reduced.

### BACKGROUND OF THE INVENTION

1. Field of the Invention

The present invention relates to an air conditioning system, and more particularly, to an air conditioning system, which includes a controller capable of converting a communication method and displaying operating information of an air conditioner.

2. Discussion of the Related Art

In a conventional air conditioning system, an interface device has to be installed in order to convert the communication method of a signal received from the outside. However, the interface device does not display operating information of air conditioners. Therefore, since a separate display device other than the interface device is further required, there has been the problem of cost increase and an increase of the installation time of the air conditioning system.

### SUMMARY OF THE INVENTION

It is an object of the present invention to provide an air conditioning system, which includes a controller capable of converting a communication method and displaying operating information of an air conditioner.

The air conditioning system of the present invention comprises: an air conditioner; a first controller networked to the air conditioner in a first communication method and displaying operating information of the air conditioner; and a second controller networked to the first controller in a second communication method and receiving a first external command for controlling the operation of the air conditioner. The first communication method is different from the second communication method, and the first controller converts a communication method of the first external command to transmit the same so that the first external command can be transmitted to the air conditioner.

In the present invention, the first controller may receive an external signal in the second communication method in response to the first external command, generate control data for controlling the air conditioner on the basis of the external signal, and send a control signal corresponding to the control data to the air conditioner in the first communication method. The first controller may comprise: a first communication module for receiving the external signal from the first controller; a control module for generating the control data on the basis of the external signal; a communication method conversion module for generating the control signal from the control data; a second communication module for sending the control signal to the air conditioner; and a display module for displaying the operating information of the air conditioner.

In the air conditioning system in accordance with the present invention, the first controller converts the communication method of an external command inputted into the second controller and transmits the same to the air conditioner. Further, the first controller displays the operating information of the air conditioner. Accordingly, the structure of the air conditioning system is simplified, and installation costs are reduced.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating the construction of an air conditioning system in accordance with a first embodiment of the present invention;

FIG. 2 is a block diagram showing in detail the constructions of a first controller and a second controller as shown in FIG. 1 and the flow of a control signal;

FIG. 3 is a screen implemented on a display module as shown in FIG. 2;

FIG. 4 is a block diagram showing the construction of an air conditioning system in accordance with another embodiment of the present invention;

FIG. 5 is a web page for authentication displayed on the screen of the second controller of FIG. 4; and

FIG. 6 is a web page showing controllable and monitorable categories displayed on the screen of the second controller of FIG. 4;

### DETAILED DESCRIPTION OF THE PREFERRED EMBODIMENTS

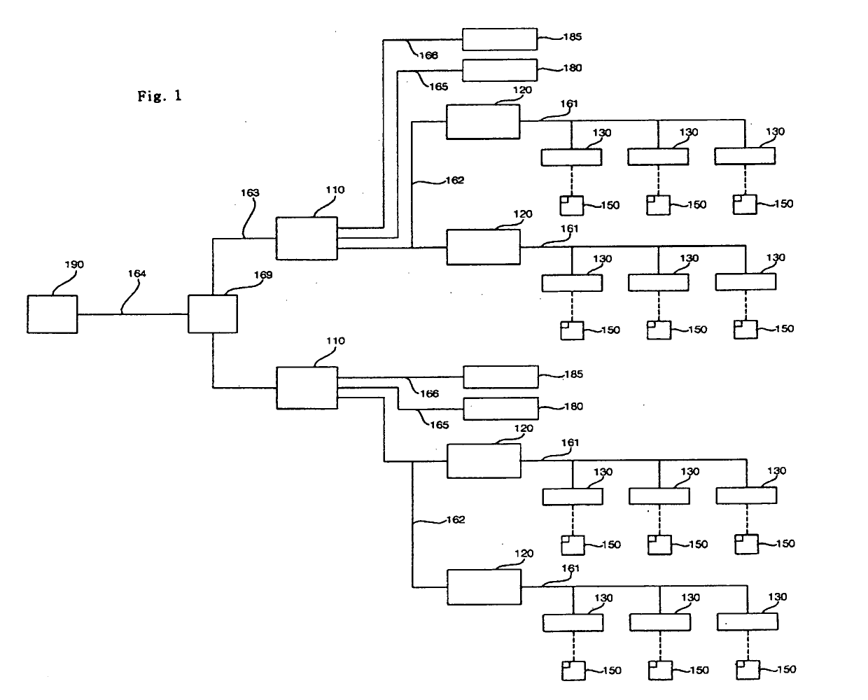

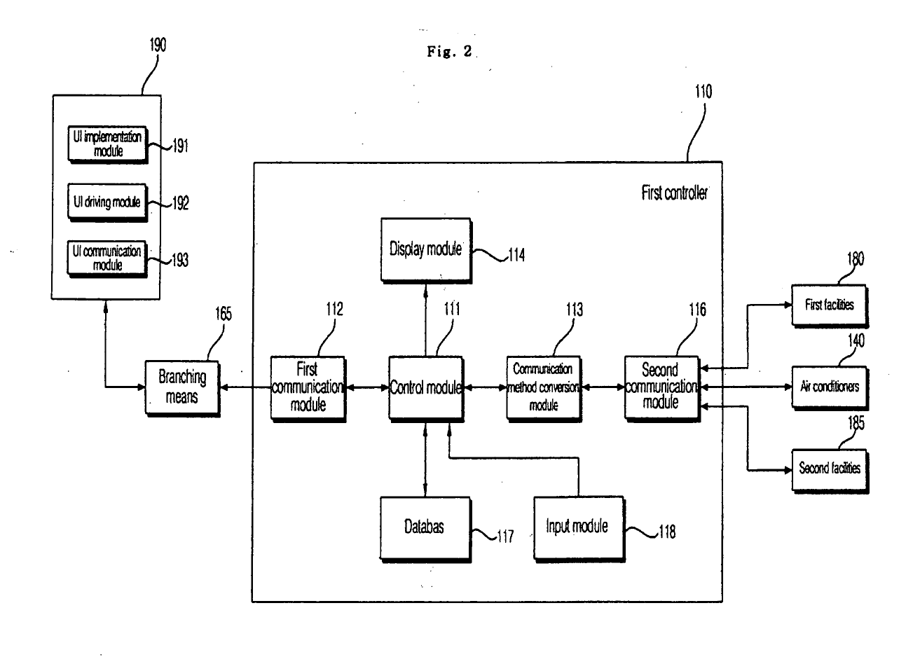

FIG. 1 is a block diagram illustrating the construction of an air conditioning system 100 in accordance with a first embodiment of the present invention. FIG. 2 is a block diagram showing in detail the constructions of a first controller 110 and a second controller 190 as shown in FIG. 1 and the flow of a control signal.

Referring to FIG. 1, the air conditioning system 100 includes air conditioners 140, local controllers 150, first controllers 110, a second controller 190, and a branching means 169. Each of the air conditioners 140 includes a plurality of indoor units 130 and an outdoor unit 120. However, the present invention is not limited thereto, but each air conditioner 140 may include a plurality of indoor units 130 and a plurality of outdoor units 120. The indoor units 130 are disposed in indoor spaces, and the outdoor unit 120 is disposed in an outdoor space. In each of the air conditioners 140, the indoor units 130 and the outdoor unit 120 are communicatively connected to each other via a first network 161. Further, the outdoor units 120 are communicatively connected to each other via a second network. RS-485-communicaiton is conducted in the first network 161 and the second network 162. However, the present invention is not limited to the above communication method.

Referring to FIG. 1, each of the local controllers 150 is disposed in each indoor space, and each of the local controllers 150 operates operating information of the air conditioner 140 in communication with the indoor units 130 disposed in indoor spaces. Each local controller 150 is provided with a plurality of operation keys (not shown), and a user operates the plurality of operation keys (not shown) to control the operation of the air conditioner 140. Furthermore, each local controller 150 further includes a display panel (not shown) for displaying operating information of the air conditioner 140. The local controllers 150 and the indoor units 130 conducts communication by wired or wireless means, and the local controllers 150 may be general wired remote controllers or wireless remote controllers.

Referring to FIGS. 1 and 2, each of the first controllers 110 is communicatively connected to the air conditioners 140 via the second network 162. The first controllers 110 are networked to the second controller 190 by a third network 163, a fourth network 164, and the branching means 169. Various devices can be selected as the branching means 169. In FIGS. 1 and 2, a hub is disposed as the branching means 169. Although in FIG. 1, the branching means 169 is installed such that the plurality of first controllers 110 can be networked to the single second controller 190, if there is only a single first controller, a separate branching means may not be required. The second controller 190 is a terminal in which a program capable of communication with the first controllers 110 can be executed. The second controller 190 includes a computer, a PDA, a portable phone and so on.

Referring to FIG. 2, the second controller 190 includes a UI implementation module 191 for displaying operating information of the air conditioners 140 and implementing a UI (user interface) so as to receive a first external command from a user; a UI driving module 192 for controlling the operation of the UI implementation module 191 and generating external command data on the basis of the first external command from the user; and a UI communication module 193 for generating an external signal on the basis of the external command data and sending the same to the first controllers 110 in the first communication method via a third network 163, the branching means 169, and the fourth network 164. The first external command includes a command corresponding to the change of the set temperature of an indoor space, a command corresponding to the change of the blast volume of the indoor units 130 and so on. The first communication method can be variously selected in consideration of the characteristics of the first controllers 110 or the like, and TCP/IP type communication is conducted in the air conditioning system 100. Also, the UI implementation module 191 is able to implement not only the UI but also a GUI (graphical user interface).

Referring to FIG. 2, each of the first controllers 110 includes a first communication module 112, a control module 111, a display module 114, a database 117, a communication method conversion module 113, an input module 118, and a second communication module 116. The first communication module 112 receives the external signal from the second controller 190. Further, the first communication module 112 can send a signal of the first controller 110 to the second controller 190. The control module 111 generates control data on the basis of the external signal. That is to say, the control module 111 generates control data for controlling the air conditioners 140 from the external signal and information of the air conditioners 140 stored in a database 117. If the first external command is a command corresponding to the change of the blast volume of a specific indoor unit 130, the control data corresponds to information for changing the number of turns of a blast fan (not shown) of the specific indoor unit 130.

The communication method conversion module 113 converts the generated control data into a second communication method to generate a control signal. The second communication method can be variously selected in consideration of the structure and characteristics of the air conditioners 140, and RS-485 type communication is used in the air conditioning system 100.

The second communication module 116 sends the control signal to the air conditioners 140 by means of the second network 162. However, the second communication module 116 may receive a signal from the air conditioners 140. At this time, the communication method conversion module 113 converts the signal received from the air conditioners 140 into the first communication method to send it to the second controller 190. Further, the communication method conversion module 113 does not only conduct the conversion between a specific first communication method and a specific second communication method but also the conversion between various first communication methods and various second communication methods. At this time, the first controllers 110 may include a plurality of communication method conversion modules corresponding to communication methods that are to be converted, and the communication method conversion module may conduct the conversion of various communication methods in terms of software.

In the second network 162, third network 163, and fourth network 164, signals are received and sent by using the same communication protocol. However, the first controllers 110 can convert a communication protocol as well as a communication method. That is to say, the first controllers 110 can conduct communication with the air conditioners 140 by using a first communication method and a first communication protocol, and conduct communication with the second controller 190 by using a second communication method and a second communication protocol. The second communication protocol may be a BACnet protocol or a LonWorks protocol.

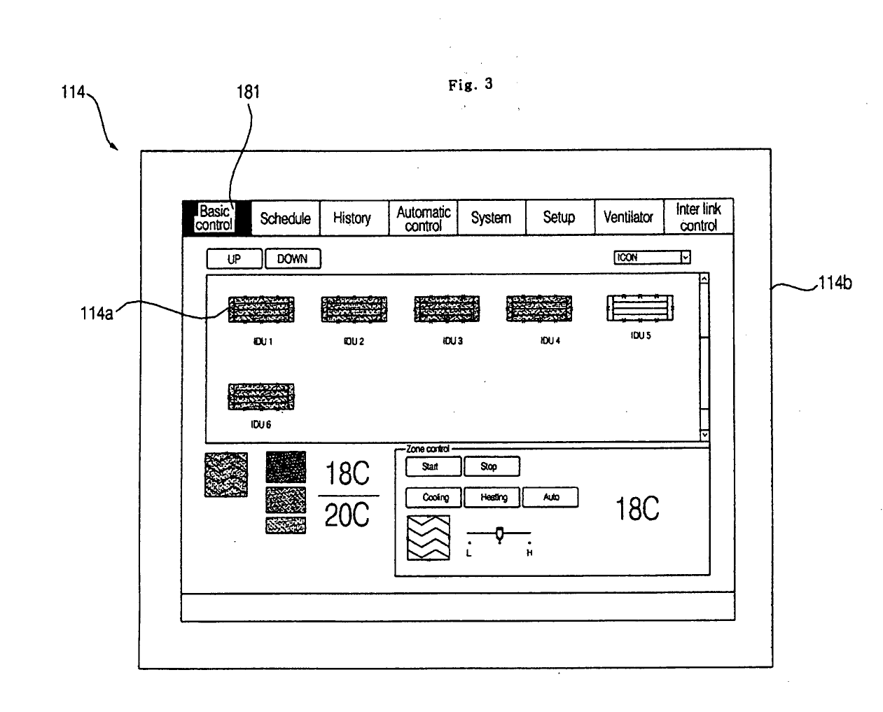

The display module 114 displays operating information of the air conditioners 140. FIG. 3 illustrates a screen implemented by the display module 114. Referring to FIG. 3, on the screen 114b of the display module, operating information on “basic control” mode, “schedule” mode, “history” mode, “auto control” mode, “system” mode, “setup” mode, “ventilating apparatus” mode, and “interlink control” mode are displayed. FIG. 3 shows a state in which the “basic” mode is selected. In the “basic control” mode, icons 114a corresponding to the respective indoor units 130 are displayed. Further, when a specific one of the icons 114a is selected, operating information of the indoor unit corresponding to the specific icon is displayed at a lower part of the screen 114b. The operating information of the indoor unit include the operation mode of the indoor unit, the room temperature of an indoor space, the set temperature of the indoor unit, the blast volume of the indoor unit, etc.

A second external command for controlling the operation of the air conditioner 140 is entered into the input module 118. The user can enter the second external command in the first controllers 110 in order to control the air conditioner 140 by using the first controllers 110 as well as the second controller 190. The input module 118 may include a plurality of operation keys. At this time, the user can enter the second external command by operating the plurality of operation keys. However, if the display module 114 as shown in FIG. 3 has a touch screen system, it is possible to enter the second external command in a touch manner. If the touch screen system is employed, the input module 118 and the display module 114 have an integral structure.

The control module 111 generates control data for controlling the air conditioner 140 on the basis of an external signal corresponding to the second external command, and the communication method conversion module 113 generates a control signal corresponding to the control data in the first communication method. The control signal is sent to the air conditioner 140 through the second communication module 116.

Referring to FIG. 2, the first communication module 112, the control module 111, the display module 114, the database 117, the communication method conversion module 113, the input module 118, and the second communication module 116 are integrally formed. Here, the expression “integrally formed” does not only mean that the components are formed so as to be inseparable from one other, but also that they are structurally coupled to one another. As the first communication module 112, the control module 111, the display module 114, the database 117, the communication method conversion module 113, the input module 118, and the second communication module 116 are all integrally formed, this has the effect of simplifying the construction of the first controllers 110. However, the present invention is not limited thereto, only some components of the first communication module 112, the control module 111, the display module 114, the database 117, the communication method conversion module 113, the input module 118, and the second communication module 116 may be integrally formed with one another.

Referring to FIGS. 1 and 2, the air conditioning system 100 further includes first facilities 180 and second facilities 185. The first facilities 180 are communicatively connected to the first controllers 110 via a fifth network 165. The first facilities 180 can be variously selected, and, in this embodiment, the first facilities 180 are ventilators. Between the first facilities 180 and the first controllers 110, communication is conducted by RS-485 communication protocol. The second controller 190 controls the operation of the first facilities 180 through the first controllers 110. However, as shown in FIG. 3, the “ventilator” mode may be selected so that the first controllers 110 can directly control the first facilities 180 and display operating information of the first facilities 180.

The first controllers 110 work in interlink with any one of the second facilities 185 and the air conditioner 140, thereby controlling the operation of the others. The second facilities 185 include firefighting equipment, lighting equipment, door locking equipment, ventilation equipment, etc. If the second facilities 185 are door locking equipment, the door of the door locking equipment may automatically stop the operation of the air conditioner 140 in interlink with the locking of the door of the door locking equipment. The second facilities 185 operate independently from the second controller 190, and are in dry contact with the first controllers 110. The second facilities 185 perform on/off communication with the first controllers 110 by using a DC power supply of 0 to 24V. The setup and operating information of the second facilities 185 are displayed upon selecting the “gang control” mode as shown in FIG. 3.

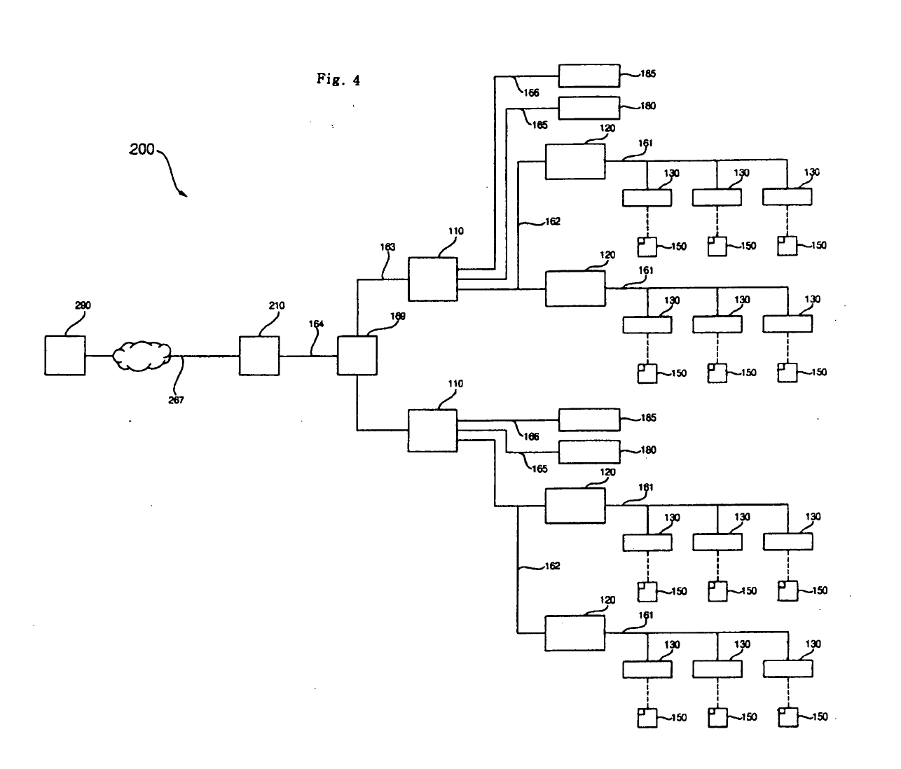

FIG. 4 is a block diagram showing the construction of an air conditioning system 200 in accordance with another embodiment of the present invention. The same reference numerals as those in the previous embodiment denote the same members. The following description will be given with respect to differences from the previous embodiment.

Referring to FIG. 4, the air conditioning system 200 includes air conditioner 140, local controllers 150, a first controller 210, and a second controller 290. As the first controller 210 and the second controller 290 are connected via the internet network 267, the first controller 210 and the second controller 290 perform communication in a TCP/IP communication method.

The first controller 210 has substantially the same functions and structures as the first controller 110 of FIG. 1 has, except that it performs the function of a web server. The second controller 290 is a device that is accessible to the web server, and includes a computer, a PDA, a mobile phone, etc. The user can execute a web browser in the second controller 290, and thereafter make a web connection to the first controller 210 on the web browser.

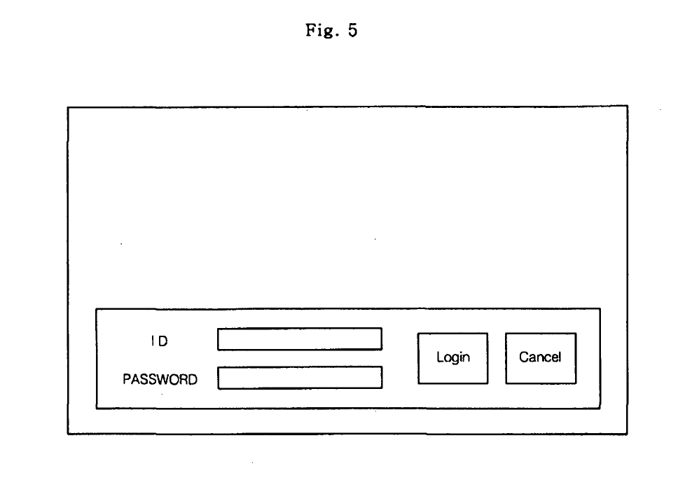

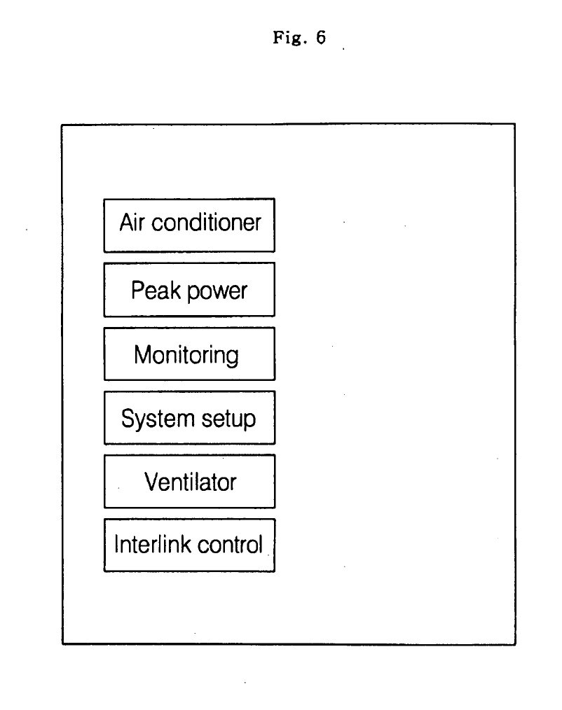

The first controller 210 transmits to the second controller 290 a web page for displaying operating information of the air conditioner 140, the first facilities 180, and the second facilities 185. The user may enter a first external command for controlling the operation of the air conditioner 140 and the first facilities 180 on the web page, and may monitor the operation state of the air conditioner 140, the first facilities 180, and the second facilities 185. Referring to FIG. 5, if the second controller 290 makes a web connection to the first controller 210, the first controller 210 transmits a web page for authentication to the second controller 290. Once an authentication procedure is performed, the first controller 210 transmits to the second controller 290 a web page showing the categories that the user can execute by means of the second controller 290. Referring to FIG. 6, the web page is illustrated.

Although the present invention has been described with reference to the embodiments shown in the drawings, these are merely illustrative, and those skilled in the art will understand that various modifications and equivalent other embodiments of the present invention are possible. Consequently, the true technical protective scope of the present invention must be determined based on the technical spirit of the appended claims.

What is claimed is:

1. An air conditioning system, comprising:
an air conditioner;
a first controller networked to the air conditioner in a first communication method and displaying operating information of the air conditioner; and
a second controller networked to the first controller in a second communication method and receiving a first external command for controlling the operation of the air conditioner,
wherein the first communication method is different from the second communication method, and
the first controller converts a communication method of the first external command to transmit the same so that the first external command can be transmitted to the air conditioner.

2. The air conditioning system of claim 1, wherein the first controller receives an external signal in the second communication method in response to the first external command, generates control data for controlling the air conditioner on the basis of the external signal, and sends a control signal corresponding to the control data to the air conditioner in the first communication method.

3. The air conditioning system of claim 2, wherein the first controller comprises:
a first communication module for receiving the external signal from the first controller;
a control module for generating the control data on the basis of the external signal;
a communication method conversion module for generating the control signal from the control data;
a second communication module for sending the control signal to the air conditioner; and
a display module for displaying the operating information of the air conditioner.

4. The air conditioning system of claim 3, wherein the control module and the communication method conversion module are integrally formed with each other.

5. The air conditioning system of claim 3, wherein the first communication module, the control module, the communication method conversion module, the second communication module, and the display module are integrally formed with each other.

6. The air conditioning system of any one of claims 1, wherein the first controller includes an input module for inputting a second external command for controlling the operation of the air conditioner, and
the first controller generates control data for controlling the air conditioner on the basis of an external signal corresponding to the second external command, and send a control signal corresponding to the control data to the air conditioner in the first communication method.

7. The air conditioning system of any one of claims 1, further comprising a facility connected to the first controller via a network,
wherein the second controller controls the operation of the facility through the first controller.

8. The air conditioning system of claim 7, wherein the facility includes a ventilator.

9. The air conditioning system of any one of claims 1, wherein the second controller makes a web connection to the first controller.

10. The air conditioning system of claim 9, wherein the first controller transmits to the second controller a web page for displaying the operating information of the air conditioner.

11. The air conditioning system of any one of claims 1, wherein the first controller and the second controller are connected via an internet network.

12. The air conditioning system of any one of claims 1, further comprising a facility operating independently from the second controller and dry contact-connected to the first controllers,
wherein the first controller works in interlink with the facility and the air conditioner to control the operation of the others.

13. The air conditioning system of claim 12, wherein the facility includes any one of firefighting equipment, lighting equipment, door locking equipment, and ventilation equipment.

14. The air conditioning system of any one of claims 12, wherein the first controller performs TCP/IP communication with the second controller, and the first controller performs RS-485 communication with the air conditioner.

15. The air conditioning system of any one of claims 1, wherein the air conditioner includes an indoor unit installed in an indoor spaces, and the first controller displays at least one of the operation mode of the indoor unit, the room temperature of the indoor space, and the set temperature of the indoor unit.

16. The air conditioning system of any one of claims 1, wherein the second controller comprises:
a UI implementation module for displaying the operating information of the air conditioner and implementing an interface so as to receive the first external command;
a UI driving module for controlling the operation of the UI implementation module and generating external command data on the basis of the first external command; and
a UI communication module for generating an external signal on the basis of the external command data and sending the same to the first controllers.
